(19) United States
(12) Patent Application Publication
(10) Pub. No.: US 2004/0143924 A1
(43) Pub. Date: Jul. 29, 2004

(54) Blade holder

(75) Inventor: Dirk Salmon, Wertheim (DE)

Correspondence Address: William R. McClellan, Wolf, Greenfield & Sacks, P.C., 600 Atlantic Avenue, Boston, MA, 02210, US

(73) Assignee: Vermop Salmon GmbH, Wertheim (DE)

(21) Appl. No.: 10/753,574

(22) Filed: Jan. 7, 2004

(30) Foreign Application Priority Data
Jan. 13, 2002 (EP) 03 000 751.2

(51) Int. Cl. B26B 3/00

(52) U.S. Cl. 15/236.1; 30/169

(57) ABSTRACT

The present invention relates to a blade holder (1) for releasable holding of a blade (5), in particular for cleaning purposes, having a first section (3) and a second section (4) connected to each other in such a way that they can be slewed with each other around an axis (6) and where the first section (3) has a first clamping surface (3′) and the second section (4) has a second clamping surface (4′) pointed towards each other and held against each other under tension by slewing the first (3) and/or the second (4) section in such a way that a blade (5) inserted between the clamping surfaces is held by the force of clamping and where the axis (6) essentially lies in the plane of the first (3′) and/or the second (4′) clamping surface and the first (3) and/or second (4) section in the tensioned condition of the clamping surfaces (3′, 4′) are held fast by means of a catch mechanism (7, 8). In this way, a blade holder is provided making possible enhanced safety in regard to cutting injuries when blades are changed.

### TECHNICAL FIELD

The present invention relates to a blade holder for releasable holding of a blade, in particular for cleaning purposes, in which a blade is held by means of a clamping force between the clamping surfaces of two sections of the blade holder.

### PRIOR ART

Blade holders of the type cited above are used according to the prior art for various cleaning purposes, for example for removing coarse dirt residues from smooth surfaces such as windows and similar surfaces.

Thus, German utility model DE 704 3159, for instance, discloses a scraper consisting of a holder with a U shaped cross-section simultaneously serving as a handle and a leaf-shaped blade squeezed between the mutually cushioning legs of the holder. The cutting edge of the blade can be covered by means of a cap attachable to the holder. The peculiarity of this blade holder consists in the fact that the blade holder is arranged so that it can be pivoted on the cover cap so that it can on the one hand be pivoted into the cover cap and on the other hand can be pivoted out of the cover cap so that the cover cap simultaneously serves as a handle.

However, in practical use of this frequently used blade holder, it has turned out that changing the blade clamped into the blade holder is not only complicated and difficult but even dangerous as well. The blade can only be pushed out of or into the blade holder with a considerable application of force to overcome the blade holder's clamping force. Due to this, changing a blade becomes on the one hand uncomfortable while on the other hand, even with the slightest lack of care there is a danger of significant injuries from cutting. The well-known blade holder is therefore particularly unsatisfactory, especially from a work safety point of view.

In addition hereto that, the firm Vileda, 69469 Weinheim, markets under the item number of 7450 a so-called safety scraper. The latter refers to a blade holder made of plastic, with which the blade is positioned in a plastic casing made of plastic runners. By activating a release head, the blade may be pushed with the runner so far out of the plastic casing into a working position that the blade edge protrudes of the casing by about 3 mm out. If the window scraper is not needed, the blade is pushed inwards so that the scraper offers adequate safety in that respect. By contrast, however, even with this scraper, changing the blade is associated with significant difficulties and dangers. To do so, the runner must be pushed sideways out of the casing with the blade. This operation is very slow and the user must grasp the protruding blade in order to pull it out, something which is totally unacceptable in respect of work safety.

### SUMMARY OF THE INVENTION

The object of the present invention is to provide a blade holder for releasable holding of a blade, in particular for cleaning-purposes, which offers enhanced safety especially when the blade is being changed and has a simple design.

This objective is solved by means of the blade holder with the features of the independent patent Claim 1.

The present invention is based on the idea of fashioning the holding or clamping of the blade in the blade holder in such a variable way that the blade is positioned securely and stably in the blade holder while in use, but is released from the blade holder for changing the blade so that the blade may be removed or ejected from the blade holder without posing any danger. For this purpose, the invention provides for the first section having a first clamping surface and the second section having a second clamping surface, the two sections being faced towards each other and being pre-tensioned against each other by moving the first and/or the second sections against each other in such a manner that a blade inserted between the clamping surfaces is held by the force of the clamps. The invention furthermore provides in this regard that the axis lies essentially in the plane of the first and/or second clamping surface and the first and second sections are fixed in the pre-tensioned condition of the clamping surfaces by means of a snap mechanism.

In this way, with the blade holder constituting the invention, a tightened or fastened condition can be brought about in which the blade is held safely and stably in the blade holder so that the latter is ready for use in work. On the other hand, the tightened condition can also be eliminated so that the clamping force between the clamping surfaces is relaxed, thereby releasing the blade so that the latter can then be removed from the blade holder without force or can be ejected by tilting the blade holder or in a similar manner.

The advantages achieved with this blade holder invention consist mainly in the fact that work safety is enhanced, particularly when changing the blades. In this way, the danger of injury when changing the blade is practically eliminated since the blades no longer need to be grasped with force and pulled out or forced out of the blade holder, but rather lie loose and ready for removal or ejection after the locked-in state has been released. By means of the interlocking of the first and second section achieved with the snap mechanism as well, any unintended opening of the blade holder, in particular during its use in work, is prevented, something which likewise enhances its work safety. In addition, the blade holder has a simple design and is easy to operate.

In accordance with a further development of the present invention, the first clamping surface has at least one projection and the second clamping surface has at least one recess basically corresponding to the projection. The one projection, at least, is in a position and its dimensions are fitted to commercially available blades normally having recesses into which at least one projection can engage. In this way, one the one hand a precisely defined position of the blade is achieved in the blade holder without any manual adjusting being required with its associated risk of injury so that work safety is enhanced even further. In addition to that, the engagement of at least one projection into the recesses of an inserted blade makes interlocking possible between the blade holder and the blade so that the holding of the blade in the blade holder is further enhanced and/or the required clamping force in the blade holder can be reduced.

In view of the (mutual) fastening of the first and second section, a further development of the present invention allows preferably for having the snap mechanism having a first snapping section on the first section and a second snapping section on the second section for mutual snapping or fastening. The provision of snapping sections has the advantage that fastening is achieved by attainment of a certain pivoting condition alone without additional locking or clamping devices such as, for instance, a cam or something similar being required. In this way, the design and operation of the blade holder are simplified.

In order to ensure a smooth release of fastening after the first and second section have been fastened, a further development of the present invention preferably provides for at least one of the snap sections being movable in relation to the other snap section. It is particularly preferable here to have at least one movable snap section biased against the engagement or snapping of the other snap section, preferably by means of an elastic element. In this way, the snap sections are held securely in an engaged or fastened position thanks to the elastic element unless one of the catch sections has been pushed away from the effect of the elastic element by the user, thus eliminating the engaged condition so that at the same time the clamping force on the blade is relaxed and the blade is thus released.

In order to achieve a compact and ergonomic construction design of the blade holder, the invention provides for having the first and second section being at least partially retractable into each other.

According to a further objective, the present invention provides a blade holder with a safety cap attachable to the blade holder in such a way that it covers the inserted blade. The safety cap thus likewise contributes to enhanced work safety by making it possible to cover the blade's cutting edge with the safety cap during work breaks, shipping, etc, so as to rule out any risk of injury whatsoever.

From an ergonomic point of view, a further development of the invention provides preferably for having the safety cap being attachable to the blade holder in such a way that the inserted blade is exposed. This on the one hand rules out being attachable to the blade holder in such a way that the inserted blade is exposed. This on the one hand rules out the loss of the safety cap during the blade holder's use in work, i.e. if the blade is released, since it is securely kept on another part of the blade holder, e.g. on its rear side. At the same time the safety cap can also serve in this condition as a handle, something that facilitates handling of the blade holder. This is a particular advantage if it is taken into consideration that when the blade holder is in use, for instance for removing coarse residues on smooth surfaces, such as window panes and similar surfaces a considerable amount of force is frequently needed.

In order to ensure stable attachment between the blade holder and the safety cap both during shipping as well as during work use, an additional further development of the present invention preferably provides the safety cap with a releasable snap means which snaps on the blade holder when the safety cap is attached to it. Particularly preferred is to have the snap means formed by means of a yoke with a snap lug coupled to the safety cap, wherein the snap lug can preferably be caught in a recess of the blade holder and the yoke most preferably has a spring to press it into the snapping position. In addition to a more secure attachment of the blade holder and the safety cap, a simple release of the two from each other is likewise made possible in this manner.

According to a further objective of the present invention, the safety cap has a magazine for storing at least one blade. This ensures that the blade holder is always ready to use even if the blade currently positioned in the blade holder has become blunt or in other respects no longer meets the requirements. Particularly preferred in this case is that the magazine is inserted into the safety cap in particular that it snaps in the latter so that the magazine and the safety cap form an ergonomic unit.

In view of the blade holder's ergonomics and versatility, a further objective of the present invention is preferably to have the blade holder and/or the safety cap have receptacle devices, particularly recesses, for a window wiper handle or similar object. By attaching the blade holder and/or the safety cap with the blade holder to a window wiper handle, the blade holder's action radius is considerably enlarged, something which is an advantage in particular in case of extensive objects to be cleaned and so forth.

### BRIEF DESCRIPTION OF THE DRAWINGS

FIG. 1 shows a schematic perspective view of an embodiment of the blade holder constituting the invention with a blade in the clamped-in position;

FIG. 2 shows a schematic perspective view of the embodiment in FIG. 1 with the blade in a released position;

FIG. 3 shows a schematic cutaway view of the embodiment in FIG. 1 where the cut runs along the line III-III;

FIG. 4 shows a schematic cutaway view of the embodiment in FIG. 2 where the cut runs along the line IV-IV;

FIG. 5 shows a schematic perspective view of the embodiment in FIG. 1 in combination with a safety cap;

FIG. 6 shows a schematic and partially cutaway perspective view of the embodiment in FIG. 5;

FIG. 7 shows a schematic perspective view of the embodiment in FIG. 5 seen from the opposite side;

FIG. 8 shows a schematic perspective view of the embodiment in FIG. 5 with the blade magazine in rolled-out position.

### DETAILED DESCRIPTION OF A PREFERRED EMBODIMENT

A preferred embodiment of the present invention is described here below with reference made to the accompanying drawings.

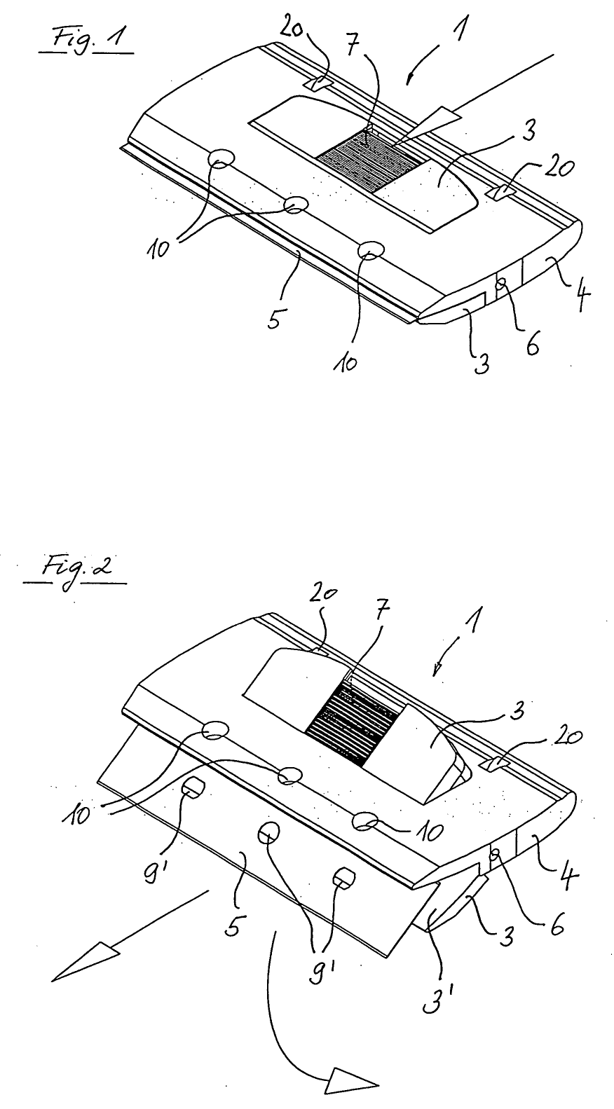

FIGS. 1 through 4 show schematic views of a preferred embodiment of the blade holder constituting the invention in isometric or cutaway presentation as well as in fastened and released condition.

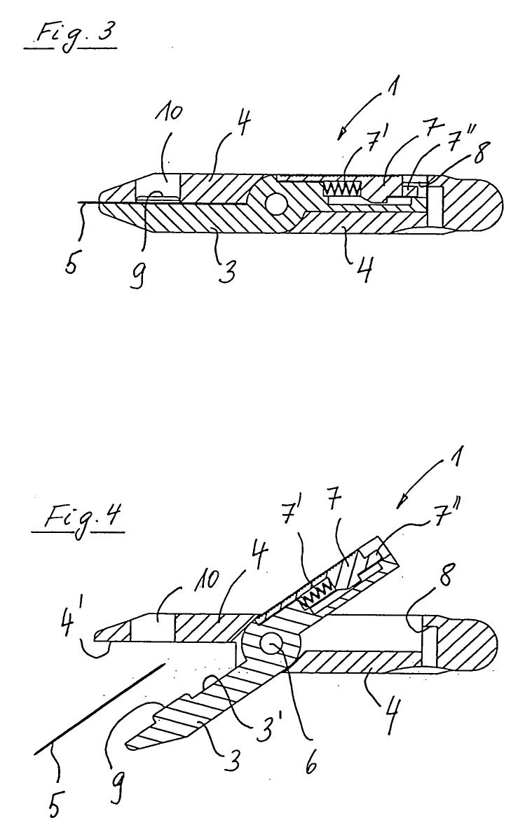

The blade holder 1 shown serves releasable holding of a blade 5 and has a first section 3 and a second section 4 connected to each other in a scissors-like manner by means of an axial pin 6 so that they can be pivoted in relation to each other around the axis 6. The first section 3 has a first clamping surface 3′ and the second section 4 has a second clamping surface 4′ which are faced towards each other. As can be seen particularly in FIGS. 3 and 4, the pivoting axis, that is the axial pin 6, lies in the present embodiment example, essentially in the plane of the first clamping surface 3′ and of second clamping surface 4′ as well. In this way, the blade holder 1 is given a particularly compact and ergonomic construction design.

In this present embodiment example, the first clamping surface 3′ has three projections 9 while the second clamping surface 4′ has three recesses essentially corresponding to the projections 9 so that the projections 9 are retractable in the recesses 10 and the clamping surfaces 3′ and 4′ can be brought into alignment with each other. In doing so, it must be ensured that the shape and number of the projections and the recesses are arranged according to the alignments 9′ available in the blade 5.

In addition to that, the first section 3 has a first snap section 7 having a snap lug 7″ while the second section 4 has a second snap section 8 in the form of a recess or equivalent. The first snap section 7 is movable along the first section 3 so that it can be brought into engagement for mutual snapping with the second snap section 8 or can be released by the same. Moreover, between the movable snap section 7 and the first element 3 a spring element 7′ is inserted that presses the first snap section 7 into a rolled-out position.

As can be readily seen from the figures, the first section 3 and the second section 4 of the blade holder 1 are shaped in such a way that they are least partially retractable in each other so that the blade holder 1, as shown in FIGS. 1 and 2, has a compact and ergonomic shape.

The components of the blade holder constituting the present invention can, in principle, be made of any suitable material. With a view to their low-cost manufacture and adequate durability in work use, it has nonetheless proven to be advantageous in particular to make the first section 3 and the second section 4 out of plastic.

The use of the blade holder constituting the invention is described below with reference made to FIGS. 1 through 4.

The FIGS. 1 and 3 show the blade holder 1 in a ready to use manner with a blade 5 securely held between the clamping surfaces 3′ and 4′. If a change of the blade 5 is required, the fastened condition of the blade holder 1 is relaxed by moving the movable snap section 7 towards the tension force of the spring 7′ in relation to the snap section 8 until the snap lug 7″ is no longer engaged with the second snap section 8 so that locking has been released. In this condition, the first section 3 and the second section 4 can be pivoted towards each other in a scissors-like manner around the axis 6 so that the clamping surfaces 3′ and 4′ are released from each other and the blade 5 is released. The blade 5 now lies loose on the first clamping surface 3′ and can be ejected into a waste container without touching the blade, for instance, by tilting the blade holder 1.

In this open position, a new blade can now be inserted into the blade holder, for instance by grasping it at the non-sharp ends and placing it on the clamping surface 3′. Correct positioning of the new blade 5 in the blade holder 1 is achieved by inserting the projections 9 of the first clamping surface 3′ into the recesses 9′ of the blade 5, something which simultaneously prevents any slippage of the blade when the blade holder is subsequently locked and which also contributes to the blade's tight fit in the blade holder. Subsequently, the first section and the second section 4 are pivoted in the opposite direction in relation to each other in a scissors-like manner until the first snap section 7 and the second snap section 8 are engaged in each other so that the blade holder 1 is fastened as a whole. In doing so, the geometry of the first section 3 and the second section 4 is laid out in such a way that the clamping surfaces 3′ and 4′ are already aligned before the fastened condition of the blade 1 is achieved, so that by the time such a fastened condition is achieved, a clamping force has built up between the clamping surfaces 3′ and 4′, this force then securing the blade 5 in a locked condition while it is in use for work purposes.

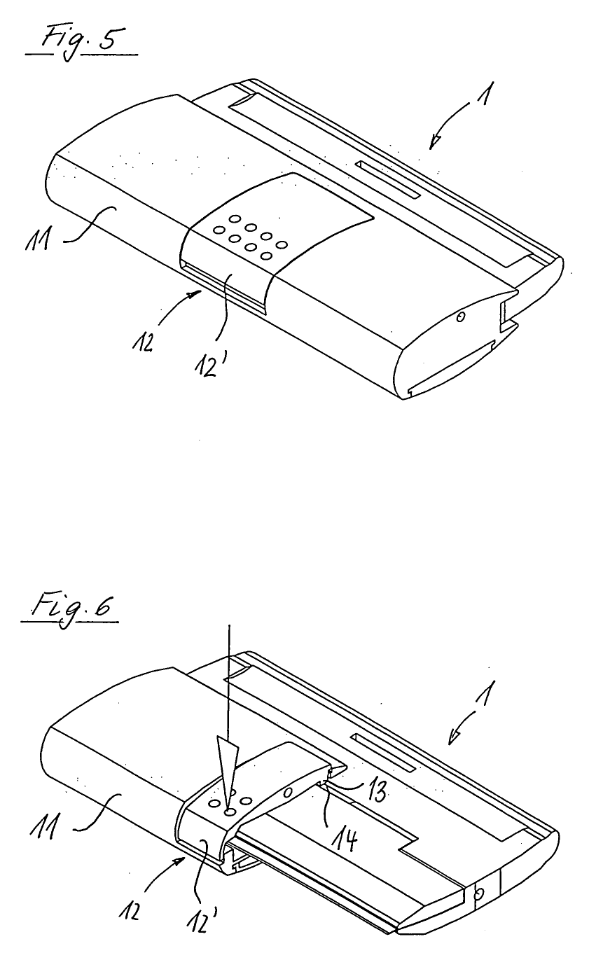

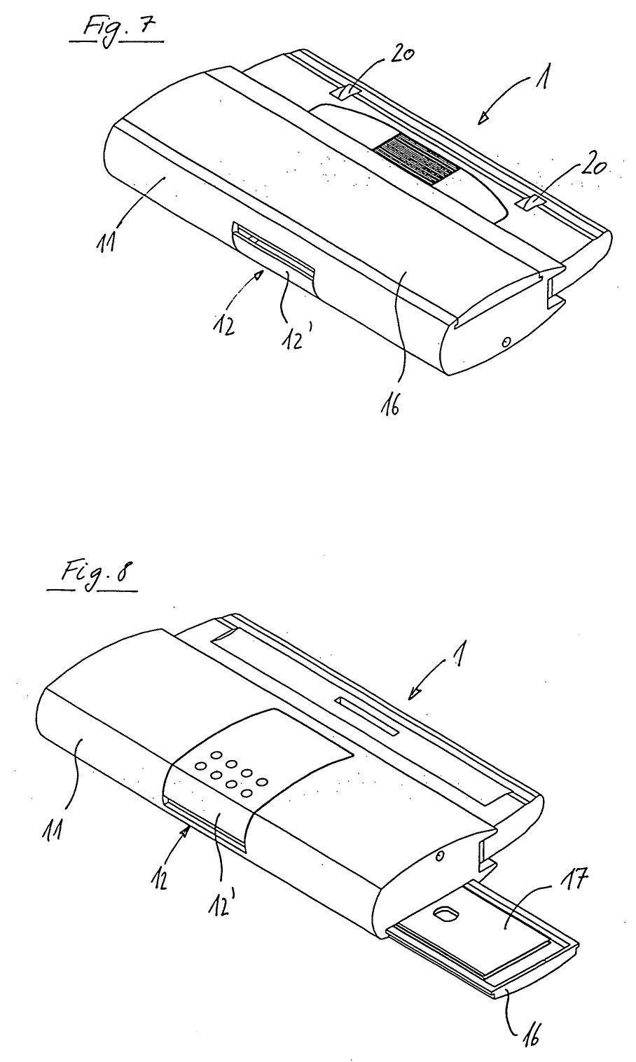

A further preferred embodiment of the present invention is described below with reference to FIGS. 5 through 8. The embodiment shown in FIGS. 5 through 8 comprises the blade holder described above with reference to FIGS. 1 through 4 plus a safety cap 11 attached to the blade holder 1 in such a way that it covers the inserted blade 5. The safety cap 11 has a releasable snap means 12 which snaps on the safety cap 11 when the latter is attached to the blade holder 1. In the present embodiment, the snap means 12 is formed by a yoke 12′ with a catch lug 13 coupled with the safety cap 11 where the snap lug snaps into a recess 14 on the blade holder 1. In order to maintain this snapped-in condition, the yoke 12′ is biased by a spring which is not shown in the figures.

To release the cover cap 11 from the blade holder 1, the yoke 12′ is activated manually so that the snap lug 13 can be released from the recess 14 against the spring's tension force and removed from the blade holder 1. The blade holder 1 is then, in principle, ready for work. In order to achieve enhanced ergonomics, the cover cap 11 can also be attached to the blade holder and locked on the same from the side of the blade holder opposite the blade 5, so that cover cap 11 simultaneously serves as an ergonomic handle for use when working.

In addition, the safety cap 11, as shown in FIG. 8, has a magazine 16 for storing extra blades 17. The magazine 16 can be snapped into place in the safety cap 12 by being pushed in and can be rolled out in order to take a blade 17 out of the safety cap 11.

Finally the blade holder 1 constituting the invention has receptacle recesses 20, by means of which the blade holder 1 can be fastened to a window wiper handle or the like. In connection with a window wiper handle the blade holder can be used fairly universally and, for instance, is also optimally suitable for large or difficult to access surfaces. Alternatively, according to the invention, provision is made for receptacle recesses 20 on the cover cap 11 so that the cover cap 11 and the blade holder 1 can be fastened to the window wiper handle or the like as a whole.

1. Blade holder for releasable holding of a blade, in particular for purposes of cleaning, having a first section and a second section connected to each other in such a way that they can be pivoted around an axis in relation to each other,
the first section having a first clamping surface and the second section having a second clamping surface which are faced towards each other and can be pre-tensioned against each other by pivoting at least one of the first and second sections in such a way that a blade is held inserted between the clamping surfaces by means of the clamping force,
wherein the axis essentially lies in the plane of at least one of the first and second clamping surfaces, and the first and second sections can be fixed in a pre-tensioned condition of the clamping surfaces by means of a snap mechanism.

2. Blade holder according to claim 1, characterised in that the snap mechanism has a first snap section on the first section and a second snap section on the second section which can snap into each other.

3. Blade holder according to claim 2, characterised in that at least one of the snap sections is movable in relation to the other snap section.

4. Blade holder according to claim 3, characterised in that the at least one movable snap section is biased in the direction of snapping with the other snap section, preferably by means of an elastic element, in particular a spring.

5. Blade holder according to claim 1, characterised in that the first and second sections are at least partially retractable in each other.

6. Blade holder according to claim 1, in combination with a safety cap attachable to the blade holder in such a way that it covers over the inserted blade.

7. Blade holder according to claim 6, characterised in that the safety cap is further attachable to the blade holder in such a way that the inserted blade is exposed.

8. Blade holder according to claim 6, characterised in that the safety cap has a releasable snap means which snaps on the blade holder when the safety cap is attached to it.

9. Blade holder according to claim 8, characterised in that the snap means is formed by a yoke with a snap lug coupled to the safety cap, wherein the snap lug can preferably be snapped into a recess of the blade holder and the yoke is more preferably biased to snap by means of a spring.

10. Blade holder according to claim 6, characterised in that the safety cap has a magazine for storing at least one blade.

11. Blade holder according to claim 10, characterised in that the magazine is led into the safety cap and in particular snaps onto it.

12. Blade holder according to claim 1, characterised in that the blade holder and/or the safety cap have receptacle devices, in particular recesses, for a window wiper handle or the like.

13. Blade holder for releasable holding of a blade, in particular for purposes of cleaning, having a first section and a second section connected to each other in such a way that they can be pivoted around an axis in relation to each other,
the first section having a first clamping surface and the second section having a second clamping surface which are faced towards each other and can be pre-tensioned against each other by pivoting at least one of the first and second sections in such a way that a blade is held inserted between the clamping surfaces by means of the clamping force,
wherein the axis essentially lies in the plane of at least one of the first and second clamping surfaces, and the first and second sections can be fixed in a pre-tensioned condition of the clamping surfaces by means of a snap mechanism,
in combination with a safety cap, wherein the safety cap is attachable to the blade holder in such a way that it covers over the inserted blade, and
wherein the safety cap is further attachable to the blade holder in such a way that the inserted blade is exposed.
